(19) United States
(12) Patent Application Publication
(10) Pub. No.: US 2004/0067753 A1
(43) Pub. Date: Apr. 8, 2004

(54) Method for setting up an additional service in a mobile radio network

(76) Inventors: Andreas Berg, Berlin (DE); Uwe Klatt, Oslo (NO); Mathias Gabrysch, Munchen (DE); Christian Wolkner, Oechsen (DE)

Correspondence Address: MORRISON & FOERSTER LLP, 1650 TYSONS BOULEVARD, SUITE 300, MCLEAN, VA, 22102, US

(21) Appl. No.: 10/456,618

(22) Filed: Jun. 9, 2003

(30) Foreign Application Priority Data
Jun. 10, 2002 (DE) 10226316.7

(51) Int. Cl. H04Q 7/20

(52) U.S. Cl. 455/435.1; 455/433

(57) ABSTRACT

The invention relates to a method for setting up an additional service in a mobile radio network.

In this case, old service data for old services which have already been set up are checked AN by an administration computer AR by means of an interrogation message AN from a home location register HLR for the mobile radio network MFN, and the checked old service data is used to determine whether additional service data which relates to the additional service can be stored in addition to the old service data in the home location register HLR. If storage is possible, the administration computer AR uses a write message EN to cause the additional service data to be stored in the home location register HLR, thus setting up the additional service.

The invention relates to a method for setting up an additional service in a mobile radio network.

In mobile radio networks according to the GSM Standard (GSM=Global System for Mobile Communication), data for the mobile radio subscribers is stored in a home location register (HLR). This data provides information, inter alia, about which network services the subscribers are using. A portion of this data defines the circumstances in which, for example, services of an intelligent network (IN) are started with the assistance of CAMEL protocols (CAMEL=Customized Applications for Mobile network Enhanced Logic). This portion of the data—referred to as service data in the following text—is also referred to as “CAMEL Subscription Information” (CSI).

In order to set up services such as these, it is feasible, when a service setting-up wish occurs in the mobile radio network, to produce a data record (a so-called ticket) which contains the necessary service setting-up data, then to evaluate such a data record off-line, and to enter the data in the home location register manually. This method is time-consuming, involves a large amount of administration, and is thus also very expensive.

The invention is based on the object of specifying a method by means of which services can be set up in mobile radio networks in a simple, cost-effective and reliable manner.

According to the invention, this object is achieved by a method for setting up an additional service in a mobile method for setting up an additional service in a mobile radio network, in which old service data for old services which have already been set up are checked by an administration computer by means of an interrogation message from a home location register for the mobile radio network, the checked old service data is used to determine whether additional service data which relates to the additional service can be stored in addition to the old service data in the home location register, if storage is possible, the administration computer uses a write message to cause the additional service data to be stored in the home location register, thus setting up the additional service, or if storage is hot possible, the setting up of the additional service is terminated. A particularly advantageous feature in this case is that the administration computer can set up additional services in an automated manner by writing additional service data in the home location register. Services which have already been set up (and which are referred to for the purposes of this application as old services) are likewise advantageously taken into account; checked data relating to these old services can be used to determine whether a new additional service can be set up in addition to the old services.

The additional services to be set up may in principle be subdivided into two categories: receiver services (MT services=Mobile Terminated Services) and sender services (MO Services=Mobile Originated Services). Receiver services are those which are started when a call arrives at a destination subscriber; sender services, in contrast, are started when a call is sent from a calling subscriber.

The method according to the invention can be refined such that, in order to set up a receiver service which is started on arrival of a destination call at a destination subscriber, the checked old service data is used to determine whether an old receiver service of a first type has been set up, which is started by means of a trigger point of a gateway mobile switching center for the mobile radio network when a call setting-up request for a call to the destination subscriber arrives at this gateway mobile switching center, whether an old receiver service of a second type has been set up, which is started by means of a trigger point of a visitor mobile switching center for the mobile radio network when a call setting-up request for a call to the destination subscriber arrives at this visitor mobile switching center, and such that the possibility of storing the service data for the receiver service in the home location register is identified only when the old receiver service of the first type and the old receiver service of the second type are not set up at the same time. In this refinement of the method according to the invention, it is advantageously possible to evaluate the types of old receiver services that have already been set up in order to determine whether a further receiver service can be set up in the mobile radio network by storing the service data for this receiver service in the home location register.

Thus, for the purposes of this application, a receiver service of the first type means a receiver service which is started by means of a trigger in a gateway mobile switching center for the mobile radio network when a call setting-up request for a call to the destination subscriber arrives at this switching center. In contrast, a receiver service of the second type is a service which is started by means of a trigger of a visitor mobile switching center for the mobile radio network when a call setting-up request for a call to the destination subscriber arrives at this visitor mobile switching center.

If neither the old receiver service of the first type nor the old receiver service of the second type has been set up, then the receiver service is set up as a new receiver service of the first type. In this case, the method according to the invention can be refined such that the service data for the new receiver service of the first type is allocated an identification which is referred to as “Terminating CAMEL Subscription Information” (T-CSI). This identification characterizes the new receiver service as a service of the first type, so that the starting time for this new receiver service is now defined.

The method according to the invention can be carried out in such a way that if only the old receiver service of the first type has been set up, and the receiver service is intended to be started at a time after the old receiver service of the first type, the receiver service is set up as a new receiver service of the second type. In this case, the service data for the new receiver service of the second type is allocated an identification which is referred to as “VMSC Terminating CAMEL Subscription Information” (VT-CSI). In this embodiment of the method, the new receiver service is identified by means of the identification VT-CSI as a service of the second type, and the starting time of this new receiver service is thus defined.

The method according to the invention can be carried out in such a way that if only the old receiver service of the first type has been set up, and the receiver service is intended to be started at a time before the old receiver service of the first type, the old receiver service of the first type is deleted and is set up as a new old receiver service of the second type, and the receiver service is set up as a new receiver service of the first type. In this case, the service data for the new old receiver service of the second type can be allocated an identification which is referred to as “VMSC Terminating CAMEL Subscription Information” (VT-CSI), and the service data for the new receiver service of the first type can be allocated an identification which is referred to as “Terminating CAMEL Subscription Information” (T-CSI). In this embodiment of the method according to the invention, it is advantageously possible by changing the service data for the old receiver service not only to deliberately produce the service data for the new receiver service but also to start the new receiver service at a time before the old receiver service.

The method according to the invention can also be refined in such a way that if only the old receiver service of the second type has been set up, and the receiver service is intended to be started at a time after the old receiver service, the old receiver service of the second type is deleted and is set up as a new old receiver service of the first type, and the receiver service is set up as a new receiver service of the second type. In this case, the service data for the new old receiver service of the first type can be allocated an identification which is referred to as “Terminating CAMEL Subscription Information” (T-CSI), and the service data for the new receiver service of the second type can be allocated an identification which is referred to as “VMSC Terminating CAMEL Subscription Information” (VT-CSI). This advantageously makes it possible to start the new receiver service at a time after the old receiver service that has already been set up.

Finally, the method can also be refined such that if only the old receiver service of the second type has been set up, and the receiver service is intended to be started at a time before the old receiver service of the second type, the receiver service is set up as a new receiver service of the first type. In this case, the service data for the new receiver service of the first type can be allocated an identification which is referred to as “Terminating CAMEL Subscription Information” (T-CSI).

The last-mentioned embodiments of the method according to the invention relate to the setting up of receiver services; the setting up of sender services will be described in the embodiments which now follow. In order to set up a sender service which is started when a call is sent by a subscriber, the checked old service data is used to determine whether an old sender service of a third type has been set up, which is started by means of a trigger point of a mobile switching center for the mobile radio network when a call setting-up request for any call originating from the subscriber arrives at this mobile switching center, whether a maximum possible number of old sender services of a fourth type have already been set up, which are started by means of trigger points of a mobile switching center for the mobile radio network when call setting-up requests for calls originating from the subscriber to preselected destination call numbers arrive at this mobile switching center, and the possibility of storing the service data for the receiver service in the home location register is identified only when the old sender service of the third type and the maximum possible number of old sender services of the fourth type have not been set up at the same time. In this case, by determining the type of old sender services which have already been set up, it is advantageously possible to determine whether it is feasible to set up the new sender service.

For the purposes of this application, the expression sender services of the third type thus means those sender services which are started by means of a trigger of a mobile switching center for the telecommunications network when a call setting-up request for any call which originates from the subscriber arrives at this mobile switching center. The expression sender services of the fourth type means those sender services which are started by means of a trigger of a mobile switching center for the mobile radio network when call setting-up requests for calls originating from the subscriber to previously selected destination call numbers arrive at this mobile switching center.

The method according to the invention can be embodied in such a way that if neither the old sender service of the third type nor the maximum possible number of old sender services of the fourth type have been set up, the sender service is set up as a new sender service of the third type. In this case, the service data for the new sender service of the third type is allocated an identification which is referred to as “Originating CAMEL Subscription Information” (O-CSI).

The method according to the invention can also be carried out in such a way that if only the old sender service of the third type has been set up, and the sender service is intended to be started at a time after the old sender service of the third type, the sender service is set up as a new sender service of the fourth type. In this case, the service data for the new sender service of the fourth type can then be allocated an identification which is referred to as “Dialled Service CAMEL Subscription Information” (D-CSI).

The method according to the invention can also be carried out in such a way that if only the old sender service of the third type has been set up, and the sender service is intended to be started at a time before the old sender service of the third type, the old sender service of the third type is deleted and is set up as a new sender service of the fourth type, and the sender service is set up as a new sender service of the third type. The service data for the new sender service of the fourth type can then be allocated an identification which is referred to as “Dialled Service CAMEL Subscription Information” (D-CSI), and the service data for the new sender service of the third type can be allocated an identification which is referred to as “Originating CAMEL Subscription Information” (O-CSI).

The method according to the invention can also be carried out in such a way that when a smaller number than the maximum possible number of old sender services of the fourth type have been set up, and the sender service is intended to be started at a time after the old sender services of the fourth type which have been set up, the sender service is set up as a further sender service of the fourth type, with a joker being preselected as the preselected destination call number for this further sender service of the fourth type. In this case, the service data for the further sender service of the fourth type can be allocated an identification which is referred to as “Dialled Service CAMEL Subscription Information” (D-CSI).

The method according to the invention can also be refined such that if only old sender services of the fourth type have been set up, and the sender service is intended to be started at a time before the old sender services of the fourth type, the sender service is set up as a new sender service of the third type. In this case, the service data for the new sender service of the third type can be allocated an identification which is referred to as “Originating CAMEL Subscription Information” (O-CSI).

The method according to the invention can be carried out in such a way that the additional services are set up in a mobile radio network which has a structure of an intelligent network (IN).

In order to explain the method according to the invention further,

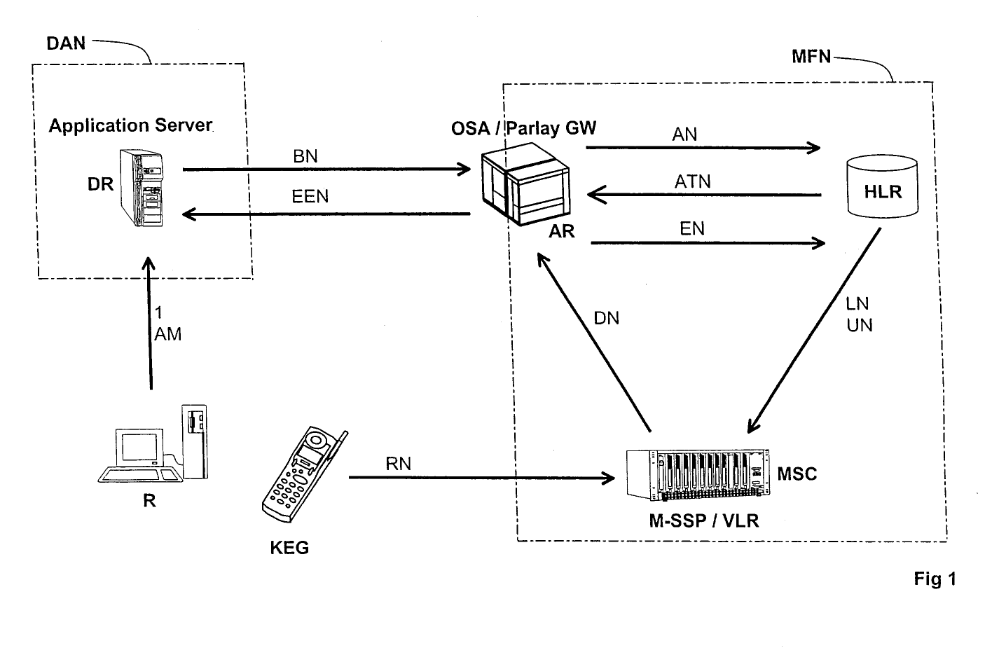

FIG. 1 shows, schematically, an exemplary embodiment of one procedure for the method according to the invention,

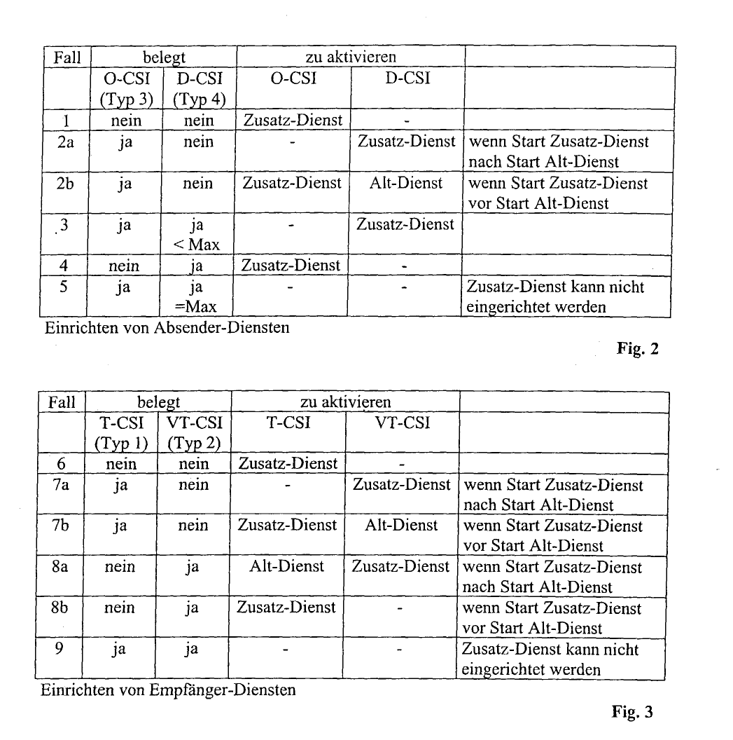

FIG. 2 shows a tabular overview of the method steps for setting up receiver services, and

FIG. 3 shows a tabular overview of the method steps for setting up sender services.

The right-hand part of FIG. 1 shows chosen elements of a mobile radio network MFN which may, for example, be a mobile radio network to the GSM Standard. These chosen elements include an administration computer AR, a home location register HLR and a mobile switching center MSC. The mobile switching center MSC may, for example, be a “Mobile Service Switching Point” with a “Visitor Location Register” (M-SSP/VLR). The administration computer AR in the illustrated exemplary embodiment is in the form of an OSA/Parlay gateway, via which a connection can be set up to a service computer DR, with the service computer DR being located in a service provider network DAN of a service provider. The service provider network DAN is in this case located outside the mobile radio network MFN. Furthermore, a communication terminal KEG is shown, by means of which services can be used via the mobile radio network MFN. A communication terminal KEG such as this may, for example, be a cellular telephone, a laptop or a palmtop with an integrated radio transmitting and receiving unit. A computer R makes it possible for a user to register for services with the service provider (to subscribe to these services).

The subscriber-specific data stored in the home location register HLR for the mobile radio subscribers includes service data which, inter alia, provides information about which network services the respective subscriber is using. This service data defines, inter alia, the circumstances in which services (for example services in an intelligent network IN) are started by means of CAMEL protocols for the mobile radio subscriber. This data is referred to as “CAMEL Subscription Information” (CSI). This CSI data is used for storing information describing the handling of the corresponding services (for example of the IN services). For example, this CSI data includes information which identifies the respective IN service, and this information is referred to as a service key. The CSI data also includes information about the network node in the intelligent network which will be given control over the service described by this CSI data. This information is referred to as a controlling SCF parameter.

The CSI data exists in various forms, for example as “Terminating CAMEL Subscription Information” (T-CSI), “VMSC Terminating CAMEL Subscription Information” (VT-CSI), “Originating CAMEL Subscription Information” (O-CSI) or as “Dialled Services CAMEL Subscription Information” (D-CSI). The T-CSI data is used to describe a receiver service (MT Service=Mobile Terminating Service) which is started when a call setting-up request for a call to a destination subscriber (for which the receiver service is set up) arrives at a gateway mobile switching center (GMSC-SSP—Gateway Mobile Switching Center—Service Switching Point) in the mobile radio network. The T-CSI thus represents an identification for such a receiver service. The identification VT-CSI describes a receiver service which is started when a call setting-up request for a call to the destination subscriber arrives at a visitor mobile switching center (VMSC-SSP=Visitor Mobile Switching Center—Service Switching Point) in the mobile radio network.

The identification O-CSI is allocated to a sender service (MO Service=Mobile Originating Service) which is started when a call setting-up request for a call originating from the subscriber to any destination call number arrives at a mobile switching center in the mobile radio network.

Finally, the identification D-CSI is allocated to a sender service which is started when call setting-up requests for calls originating from the subscriber to specific preselected destination call numbers arrive at the mobile switching center for the mobile radio network. In this case, a dedicated associated destination call number is preselected for each sender service, and is stored together with the other service data in the home location register HLR.

CSI versions such as these are described on pages 31 to 34 of the document “3GPP TS 23.078 V4.2.0—3^{rd} Generation Partnership Project; Technical Specification Group Core Network; Customized Applications for Mobile network Enhanced Logic (CAMEL) Phase 3—Stage 2 (Release4)” dated September 2001.

The version of the CAMEL Subscription Information CSI is thus the deciding factor regarding whether the corresponding service is started as a receiver service or as a sender service. Furthermore, the version of the CSI data also stipulates precisely when the service is intended to be started, that is to say for example when specific call setting-up organization messages arrive in specific switching centers.

By way of example, the following text describes the way in which the method is carried out when a service user uses the computer R to register for a sender service (MO service) (subscribing for this service). In a very simple case, this sender service may be a service which plays back a welcome message to the sender when sending any desired call (“Good Morning. Today is Monday the 3rd March; the time is 08 13”). The described method may, of course, also be used to register for any other (for example more complicated) services.

The service user's computer R is, for example, connected to the service computer DR of the service provider via an Internet link 1. The computer R uses this Internet link 1 to send a registration message AM to the service computer DR, with the registration message AM containing the nature of the respective service and the address (user address) of the communication terminal which intends to make use of the service (in this case the mobile radio call number MSISDN of the communication terminal KEG). This registration message AM may, for example, be transmitted using the normal HTTP (HTTP=Hypertext Transfer Protocol) data transmission protocol for the Internet. The corresponding mobile radio subscriber registers with the service computer DR of the service provider by means of the registration message AM.

The service computer DR then sends at least some of the data received with the registration message AM on to the administration computer AR by means of a notification message BN. This notification message BN includes, inter alia, the user address MSISDN. In this specific exemplary embodiment, the notification message BN is the OSA message “EnableCallNotification”.

The administration computer AR then sends an interrogation message AN to the home location register HLR. This interrogation message AN may, for example, be the MAP message “Anytime Subscription Interrogation” (ATSI). This interrogation message AN is used for transmitting the user address MSISDN to the home location register HLR.

In response to this interrogation message AN, the home location register HLR determines the services for which the user with the user address MSISDN has already registered, and sends information about these services together with the respective CSI data (T-CSI, VT-CSI, O-CSI or D-CSI) back to the administration computer AR by means of a response message ATN. The response message ATN may, for example, be the MAP message “Anytime Subscription Interrogation acknowledge” (ATSI-Ack). The response message ATN thus transmits “old service data” for services which have already been set up (old services) to the administration computer AR. The administration computer AR now knows which services are stored in conjunction with the CIS data in the home location register HLR, that is to say which services are set up for the respective user. On the basis of the versions of the CSI data which are already provided with services (which already use the services), the administration computer AR can decide whether it is possible to set up the desired sender service (that is to say whether service data [additional service data] relating to the service to be set up can be stored in the home location register HLR in addition to the old service data), and can define which version of the CSI data is associated with the service, that is to say which CSI data is “activated” for that service. This part of the method will be described in more detail further below.

This part of the method results in the administration computer AR knowing how the service that is to be set up is intended to be set up in the home location register, that is to say how the service data for the service that is to be set up is linked to specific CSI data, and which version of the CSI data is used for this specific service. The administration computer AR now sends a write message EN to the home location register HLR. This write message EN may, for example, be the MAP message “anyTimeModification” (ATM). This message is used, inter alia, to transmit the user address MSISDN, the new “Controlling SCF” parameter (which contains the address of the administration computer AR), the nature of the service and the version of the CSI to the home location register HLR. The MAP message “anyTimeModification” has a new data field, which contains the parameter “NewControllingSCF”, added to it for use as the write message EN. In this specific example, this data field contains the address of the administration computer AR.

The home location register HLR then stores the received data for the service that is to be set up as additional service data. The (additional) service is in this way set up in the home location register HLR. This setting-up process is acknowledged to the administration computer AR by means of an “ATM Acknowledge” message.

The home location register HLR now ensures that the modified service data is also available in those mobile switching centers which contain a visitor location register VLR. To do this, the home location register HLR sends a delete message LN to the mobile switching center MSC (which contains a visitor location register VLR), resulting in the deletion of the service data which is stored in this visitor location register—and is now obsolete. The MAP message “CancelLocation” may be sent, for example, as such a delete message LN. The home location register HLR then sends an update message UN to the mobile switching center MSC which contains the new—now valid—service data for the user. This service data is stored in the visitor location register for the mobile switching center MSC, in order to update the database for the visitor register for the mobile switching center MSC. By way of example, the MAP message “Insert Subscriber Data” may be sent as an update message UN such as this, inter alia containing the address MSISDN of the communication terminal KEG and, as the “newControlling SCF” parameter, the address of the administration computer AR.

If a user of the communication terminal KEG now uses this communication terminal KEG to transmit a call at a later time, then a call message AN is sent from the communication terminal KEG to the mobile switching center MSC. The mobile switching center MSC uses the mobile radio call number MSISDN that is transmitted with the call message RN to identify, by comparison with the service data that is stored in the mobile switching center, that a sender service is set up for the communication terminal KEG (or for its user). The mobile switching center MSC then sends a service message DN to the administration computer AR because the mobile switching center MSC knows the control device that is responsible for that service (in this case the administration computer AR) on the basis of the “New Controlling SCF” parameter which is stored in the mobile switching center MSC or in the associated visitor location register. It is possible, for example, for the CAP message “Initial DP” to be sent as the service message DN, containing the nature of the service that has been set up, in addition to the mobile radio call number MSISDN. The administration computer AR then sends an event message EEN to the service computer DR for the service provider. This event message EEN may, for example, be the OSA message “CallEventNotify”. The event message EEN is used, inter alia, to transmit the mobile radio call number MSISDN of the subscriber and information which identifies the service to be provided. The service computer DR then knows that the corresponding service is intended to be provided for the subscriber with the corresponding mobile radio call number, and the service computer DR will then provide this service using the mobile radio network MFN. This is not shown in FIG. 1.

The procedures which are carried out in the administration computer AR between the arrival of the response message ATN and the sending of the write message EN will be described in detail in the following text. With the response message ATN, the administration computer AR receives the information regarding which services the respective service user has subscribed to (that is to say the services for which that service user has registered), and which specific versions of CSI data (that is to say, for example, T-CSI, VT-CSI, O-CSI or D-CSI) are linked to these services. In the described example, in which the aim is to set up a sender service, the administration computer evaluates the identifications O-CSI and D-CSI by the administration computer AR checking whether services are associated with the O-CSI or D-CSI. In this case, the following options may occur:

Case 1) If it is evident from the checked old service data that no sender service of the third type has yet been set up for the subscriber and that in consequence no service data associated with the identification “O-CSI” is stored in the home location register HLR and that no sender service of the fourth type has yet been set up for the subscriber and that in consequence no service data associated with the identification “D-CSI” is stored in the home location register HLR, then the sender service which is to be set up from new is set up as a sender service of the third type, that is to say the additional service data for this sender service is associated with the identification “O-CSI” and is stored in the home location register. This situation is formulated in technical language as follows: “If neither the O-CSI nor the D-CSI is being used, then the administration computer AR activates the new sender service that is to be set up on the O-CSI.”

Case 2) If the O-CSI is already being used with an old sender service, but the D-CSI is not yet being used with an old sender service, then the critical factor for setting up the new sender service is whether the old service that has already been set up or the additional service which is to be set up as new should be regarded as the first to be started in time.

Case 2a) If the already available old service that has been set up is the first to be started in time, then the D-CSI is activated for the additional service to be set up as new. In this case, a joker (for an undefined digit) or a zero (for national/international distinguishing digits) is set as the “Dialled Number” parameter for the D-CSI. (In addition, it should be noted in this context that, when setting up a further service which is linked to a specific telephone number via the D-CSI, this further service is started before the service that is set up with a joker or zero.)

Case 2b) If the already available old service is intended to be started after the service that has to be set up as new, then both the old service and the sender service that is to be set up as new are linked to a new version of the CSI by a respective write message. Specifically, the D-CSI is activated for the old service, and the O-CSI for the service that is to be set up as new. In this case, the original association between the old service and the O-CSI is deleted.

Case 3) If the O-CSI is being used with an old service and if the D-CSI is being used with less than the maximum possible number of sender services (the D-CSI may, for example, be used with a maximum of 10 services), then the D-CSI is also activated for the service that is to be set up as new. The service is thus set up as a further service via the D-CSI.

Case 4) If the O-CSI is not being used and the D-CSI is being used, and if the service that is to be set up as new is intended to be started before the old services, then the O-CSI is activated for the service that is to be set up as new.

Case 5) If both the O-CSI and the D-CSI are already being used with the maximum number of services that can be set up, then the service that is to be set up as new cannot be set up because there is no more memory capability for the service data of the service that is to be set up as new. The administration computer AR will therefore terminate the setting-up procedure and will send a corresponding information message to the service computer DR.

The differences between these cases are shown once again, in summarized form, in the table in FIG. 2.

Once, using the abovementioned rules 1) to 5), the administration computer AR has determined which CSI identifications must be activated for the service that is to be set up as new and, possibly, for old services, it sends appropriate write messages to the home location register HLR, thus storing the service data in the home location register and thus initiating the process of setting up the additional service.

Now that the method for setting up sender services has been explained, the method for setting up receiver services (mobile terminated services) will be described in the following text:

When a receiver service is to be set up as new, the administration computer AR then evaluates the contents of the response message ATN by determining whether the T-CSI or the VT-CSI is already being used with services for the appropriate subscriber. The following different cases may occur in this context:

Case 6) If neither the T-CSI nor the VT-CSI is being used, then the administration computer AR activates the T-CSI for the service that is to be set up as new.

Case 7) If the T-CSI is being used, but the VT-CSI is not being used, then it is necessary to consider the time sequence in which the old service which is already available is intended to be started with respect to the service that is to be set up as new:

Case 7a) If the already available old service is to be started before the service that is to be set up as new, then the VT-CSI is activated for the service that is to be set up as new.

Case 7b) If, however, the old service which has already been set up is to be started after the service that is to be set up as new, then a first write message EN is used to activate the VT-CSI for the already available old service, and a second write message is used to activate the T-CSI with the service that is to be set up as new. The original link with the old service that has already been set up is thus deleted.

Case 8) If the VT-CSI is in use but the T-CSI is not in use, then it is necessary to take account of the time sequence in which the already available old service is intended to be started with respect to the service that is to be set up as new:

Case 8a) If the old service which has already been set up is to be started before the service that is to be set up as new, then a first write message EN is used to activate the T-CSI for the already available old service, and a second write message is used to activate the VT-CSI with the service that is to be set up as new. The original link with the old service that has already been set up is thus deleted.

Case 8b) If the already available old service is to be started after the service that is to be set up as new, then the T-CSI is activated for the service that is to be set up as new.

Case 9) If the T-CSI and the VT-CSI are already each being used by an old service, then the service that is to be set up as new cannot be set up. The administration computer AR will thus terminate the setting-up procedure, and will send an appropriate message to the service computer DR.

The differences between these cases are shown once again, in summarized form, in the table in FIG. 3.

One particular advantage of the described method is that the simultaneous use of the T-CSI and of the VT-CSI makes it possible to set up more than one receiver service for use by one subscriber. The simultaneous use of the O-CSI and of the D-CSI likewise makes it possible to set up more than one sender service per subscriber.

1. A method for setting up an additional service in a mobile radio network (MFN), in which
old service data for old services which have already been set up are checked (AN) by an administration computer (AR) by means of an interrogation message (AN) from a home location register (HLR) for the mobile radio network (MFN),
the checked old service data is used to determine whether additional service data which relates to the additional service can be stored in addition to the old service data in the home location register (HLR),
if storage is possible, the administration computer (AR) uses a write message (EN) to cause the additional service data to be stored in the home location register (HLR), thus setting up the additional service, or
if storage is not possible, the setting up of the additional service is terminated.

2. The method as claimed in claim 1, characterized in that,
in order to set up a receiver service which is started on arrival of a destination call at a destination subscriber, the checked old service data is used to determine
whether an old receiver service of a first type has been set up, which is started by means of a trigger point of a gateway mobile switching center for the mobile radio network (MFN) when a call setting-up request for a call to the destination subscriber arrives at this gateway mobile switching center,
whether an old receiver service of a second type has been set up, which is started by means of a trigger point of a visitor mobile switching center for the mobile radio network (MF) when a call setting-up request for a call to the destination subscriber arrives at this visitor mobile switching center, and
in that the possibility of storing the service data for the receiver service in the home location register (HLR) is identified only when the old receiver service of the first type and the old receiver service of the second type are not set up at the same time.

3. The method as claimed in claim 2, characterized in that
if neither the old receiver service of the first type nor the old receiver service of the second type has been set up, the receiver service is set up as a new receiver service of the first type.

4. The method as claimed in claim 3, characterized in that
the service data for the new receiver service of the first type is allocated an identification which is referred to as “Terminating CAMEL Subscription Information” (T-CSI).

5. The method as claimed in claim 2, characterized in that
if only the old receiver service of the first type has been set up, and the receiver service is intended to be started at a time after the old receiver service of the first type, the receiver service is set up as a new receiver service of the second type.

6. The method as claimed in claim 5, characterized in that
the service data for the new receiver service of the second type is allocated an identification which is referred to as “VMSC Terminating CAMEL Subscription Information” (VT-CSI).

7. The method as claimed in claim 2, characterized in that
if only the old receiver service of the first type has been set up, and the receiver service is intended to be started at a time before the old receiver service of the first type, the old receiver service of the first type is deleted and is set up as a new old receiver service of the second type, and
the receiver service is set up as a new receiver service of the first type.

8. The method as claimed in claim 7, characterized in that
the service data for the new old receiver service of the second type is allocated an identification which is referred to as “VMSC Terminating CAMEL Subscription Information” (VT-CSI), and
the service data for the new receiver service of the first type is allocated an identification which is referred to as “Terminating CAMEL Subscription Information” (T-CSI).

9. The method as claimed in claim 2, characterized in that
if only the old receiver service of the second type has been set up, and the receiver service is intended to be started at a time after the old receiver service, the old receiver service of the second type is deleted and is set up as a new old receiver service of the first type, and
the receiver service is set up as a new receiver service of the second type.

10. The method as claimed in claim 9, characterized in that
the service data for the new old receiver service of the first type is allocated an identification which is referred to as “Terminating CAMEL Subscription Information” (T-CSI), and
the service data for the new receiver service of the second type is allocated an identification which is referred to as “VMSC Terminating CAMEL Subscription Information” (VT-CSI).

11. The method as claimed in claim 2, characterized in that
if only the old receiver service of the second type has been set up, and the receiver service is intended to be started at a time before the old receiver service of the second type, the receiver service is set up as a new receiver service of the first type.

12. The method as claimed in claim 11, characterized in that
the service data for the new receiver service of the first type is allocated an identification which is referred to as “Terminating CAMEL Subscription Information” (T-CSI).

13. The method as claimed in claim 1, characterized in that,
in order to set up a sender service which is started when a call is sent by a subscriber, the checked old service data is used to determine
whether an old sender service of a third type has been set up, which is started by means of a trigger point of a mobile switching center for the mobile radio network (MFN) when a call setting-up request for any call originating from the subscriber arrives at this mobile switching center,
whether a maximum possible number of old sender services of a fourth type have already been set up, which are started by means of trigger points of a mobile switching center for the mobile radio network (MFN) when call setting-up requests for calls originating from the subscriber to preselected destination call numbers arrive at this mobile switching center, and
in that the possibility of storing the service data for the receiver service in the home location register is identified only when the old sender service of the third type and the maximum possible number of old sender services of the fourth type have not been set up at the same time.

14. The method as claimed in claim 13, characterized in that
if neither the old sender service of the third type nor the maximum possible number of old sender services of the fourth type have been set up, the sender service is set up as a new sender service of the third type.

15. The method as claimed in claim 14, characterized in that
the service data for the new sender service of the third type is allocated an identification which is referred to as “Originating CAMEL Subscription Information” (O-CSI).

16. The method as claimed in claim 13, characterized in that
if only the old sender service of the third type has been set up, and the sender service is intended to be started at a time after the old sender service of the third type, the sender service is set up as a new sender service of the fourth type.

17. The method as claimed in claim 16, characterized in that
the service data for the new sender service of the fourth type is allocated an identification which is referred to as “Dialled Service CAMEL Subscription Information” (D-CSI).

18. The method as claimed in claim 13, characterized in that
if only the old sender service of the third type has been set up, and the sender service is intended to be started at a time before the old sender service of the third type, the old sender service of the third type is deleted and is set up as a new sender service of the fourth type, and
the sender service is set up as a new sender service of the third type.

19. The method as claimed in claim 18, characterized in that
the service data for the new sender service of the fourth type is allocated an identification which is referred to as “Dialled Service CAMEL Subscription Information” (D-CSI), and
the service data for the new sender service of the third type is allocated an identification which is referred to as “Originating CAMEL Subscription Information” (O-CSI).

20. The method as claimed in claim 13, characterized in that
when a smaller number than the maximum possible number of old sender services of the fourth type have been set up, and the sender service is intended to be started at a time after the old sender services of the fourth type which have been set up, the sender service is set up as a further sender service of the fourth type, with a joker being preselected as the preselected destination call number for this further sender service of the fourth type.

21. The method as claimed in claim 20, characterized in that
the service data for the further sender service of the fourth type is allocated an identification which is referred to as “Dialled Service CAMEL Subscription Information” (D-CSI).

22. The method as claimed in claim 13, characterized in that
if only old sender services of the fourth type have been set up, and the sender service is intended to be started at a time before the old sender services of the fourth type, the sender service is set up as a new sender service of the third type.

23. The method as claimed in claim 22, characterized in that
the service data for the new sender service of the third type is allocated an identification which is referred to as “Originating CAMEL Subscription Information” (O-CSI).

24. The method as claimed in one of claims 1 to 23, characterized in that
the additional services are set up in a mobile radio network which has a structure of an intelligent network (IN).
